(19) United States
(12) Patent Application Publication
(10) Pub. No.: US 2005/0032412 A1
(43) Pub. Date: Feb. 10, 2005

(54) Termination device e.g. for a multiconnector

(76) Inventors: Masud Bolouri-Saransar, Zacco (DK); Stanley Madsen, Zacco (DK)

Correspondence Address: LADAS & PARRY, 26 WEST 61ST STREET, NEW YORK, NY, 10023, US

(21) Appl. No.: 10/168,605

(22) PCT Filed: Dec. 29, 2000
(86) PCT No.: PCT/DK00/00740

(30) Foreign Application Priority Data
Dec. 30, 1999 (DK) PA 1999 01877

(51) Int. Cl. H01R 4/24

(52) U.S. Cl. 439/409

(57) ABSTRACT

A termination device e.g. for a multiconnector comprises a cover (2) which is rotatably hinged to a housing (1), and which has a hole for receiving a cable containing a plurality of wires (5a-e). When the individual wires are arranged in respective slits in the cover, the housing and the cover may be rorated mutually to a closed position, so that the wires are gradually inserted into respective terminals for providing an electrical connection. This reduces the required closing force, and the cover may therefore be closed by hand without the use of a special tool.

The invention relates to a termination device e.g. for a multiconnector and comprising a plurality of protruding terminals and a cover which, upon closing of the device, is adapted to guide and force a wire associated with each terminal down into the terminal to provide an electrical connection between the wire and the terminal.

A multiconnector having a closure device of the above-mentioned type is known e.g. from European Patent Application No. 907 226. With this and other known techniques, the wires must first be arranged in a cover which is a loose part relative to the part containing the terminals, so that it is difficult to guide the cover and the terminals relative to each other during closing. The operation is additionally impeded in that it is normally necessary to use a special tool, because the known covers are adapted such that all terminals are affected simultaneously for insertion of a wire.

The object of the invention is to provide a termination device which may be closed more easily and without the use of tools relative to the prior art. The invention is not restricted to multiconnectors, but will be explained below in relation to multiconnectors.

This object is achieved in that the cover is hinged to the multiconnector such that the wires may be positioned correctly in an open position, and such that the wires are in place in the respective terminals in a closed position, and that the distance from the hinge axis to the terminals varies substantially evenly distributed between a smallest distance and a greatest distance.

When the terminals are differently spaced from the hinge axis, the various terminals will gradually cooperate with the respective wires as the cover is closed around the hinge axis. Thus, it is not so that all terminals have to be expanded at the same time, and it is therefore easier to force the wires down into the terminals in turn. The hinge also means that the parts are better positioned relative to each other during the closing movement. An optimum distribution of the applied forces during the closing movement is achieved in that all terminals are differently spaced from the hinge axis.

Since terminals and wires will describe a circular arc movement around the hinge axis when the cover is closed, it is expedient that the terminals are elastic transversely to the hinge axis. Another embodiment may be that the slit between the terminals for receiving a wire is arc-shaped and positioned concentrically around the hinge axis.

Before the multiconnector is closed, the wires are arranged in position in the cover, which has grooves for receiving an associated wire. The grooves may have a width which corresponds to the thickness of the wire so that the wires are fixed in the groove, but compensation for the above-mentioned arc-shaped movement may also be achieved in that the grooves close to the hinge axis are wider than the grooves which are positioned further away from the hinge axis. Preferably, the grooves are open toward a pair of opposed sides of the cover so that the wire ends can protrude freely substantially in parallel with the hinge axis, which makes it very easy to cut off the wires so that they are flush with said sides before the cover is closed.

In a preferred embodiment, a through hole is provided from the top of the cover to the bottom of the cover, and as the grooves are preferably positioned at the bottom of the cover, a cable may be inserted from the top, following which the wires of the cable may be arranged in the grooves at the bottom of the cover. Alternatively, another of the sides of the cover may be provided with a hole for receiving a cable.

The invention will be explained more fully by the following description of some embodiments with reference to the drawing, in which

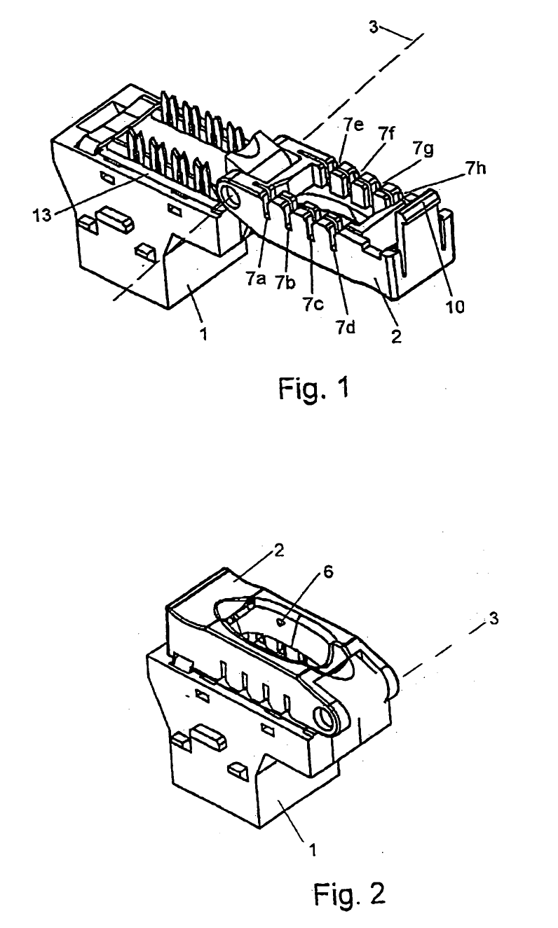

FIGS. 1 and 2 show a first embodiment of the termination device according to the invention,

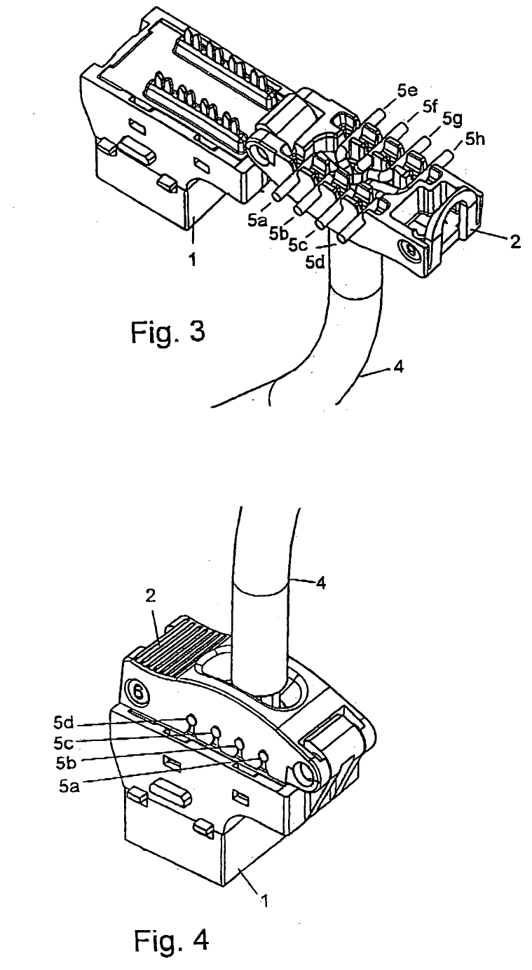

FIGS. 3 and 4 show the termination device shown in FIGS. 1 and 2, but with an inserted cable containing a plurality of wires, while

FIGS. 5-7 show a second embodiment of the termination device according to the invention.

FIG. 1 shows a housing 1 and a cover 2 which is rotatably mounted on the housing 1 about an axis of rotation 3. The housing and the cover may form a multiconnector, so that the bottom of the housing might be adapted to receive a counterpart of a multiconnector, but the housing 1 might also have downwardly extending solder pins for mounting on a printed circuit board. It is also conceivable that the bottom of the housing 1 is provided with a cover corresponding to the cover 2 with associated terminals. The embodiments will be described below under the designation multiconnector.

FIG. 2 shows the parts shown in FIG. 1 in a closed position, while FIGS. 3 and 4 show the same as FIGS. 1 and 2, but with an inserted cable 4. In the embodiment shown, the cable 4 may contain up to eight wires which are shown at 5a-h. The cable is inserted into an opening 6 in the cover, as will be seen best in FIG. 2, and the outer jacket is removed so that the individual wires protrude freely. Then, the wires may be arranged in respective slits 7a-h. The open end of the slits facing upwards in FIG. 1 is bevelled so that it is easy to introduce the wires 5a-h into the terminals. The terminals are also positioned such that it is easy to shorten the wires with cutting pliers, as is indicated in FIG. 4.

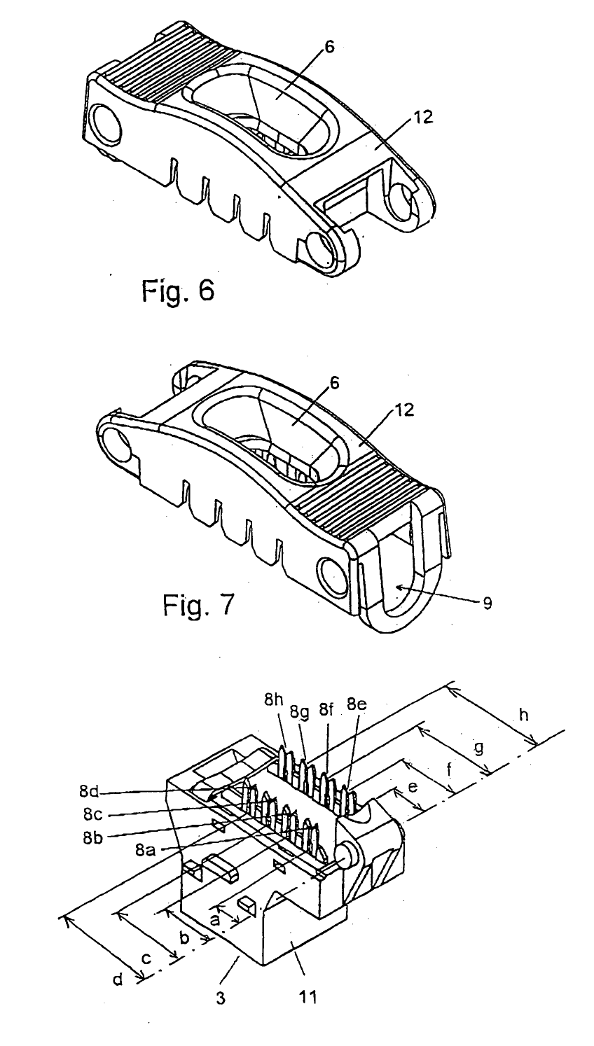

FIG. 5 shows another housing 11, and the associated cover 12 can be seen in FIGS. 6 and 7. In FIG. 5, the terminals are designated 8a-e, and the distances a-e drawn in the figure show the distances of the respective terminals from the axis of rotation 3. According to the invention, the terminals are differently spaced from the axis of rotation 3, and in a preferred embodiment all distances are mutually different. This means that the closing force may be reduced relative to the prior art where all wires are forced down into the respective slits at the same time. The invention also covers the embodiment that the terminals are just arranged at two mutually different distances from the axis of rotation 3.

It will be appreciated that the terminals and/or the individual wires 5a-e will describe a circular arc movement around the axis of rotation 3 when the cover is closed, and one would therefore believe that it might cause problems to prevent in particular the innermost wires from getting squeezed during the closing movement. This is prevented in several ways. For one thing, it will be seen that the uppermost opening of the terminals is V-shaped so that the respective wire is moved down into the terminal during the closing movement, but according to the invention the terminals 8a-e may also be resilient transversely to the axis of rotation 3. Even though it is preferred that the slits 7a-e are so narrow that they can fix the wires temporarily during the closing movement, it is also conceivable that in particular the innermost slits 7a and 7e are wider than the outermost ones 7d and 7h. Another solution is that the slits of the terminals might be arc-shaped and positioned substantially concentrically relative to the axis of rotation 3. A further option is indicated in FIG. 5. The protective rails, which are shown at 13 in FIG. 1, are removed in FIG. 5 to show that, at the top, the terminals have a wire-receiving part and below this a wide slit, which means that the terminals are elastic in a direction transversely to the axis of rotation 3. However, it has been found in practice that there is no appreciable need for compensation for the circular arc movement of the wires. When the device according to the invention is intended for the mounting of copper wires in tinned terminals, the invention also utilizes the circumstance that a certain flow of said metals takes place to ensure a good electrical connection.

The cover 12 shown in FIGS. 6 and 7 also has a through hole 6 for a cable, but, as will appear from FIG. 7, a side of the cover may also comprise a hole 9 for receiving a cable. In the embodiment shown in FIG. 7, the lowermost part of the wall, in which the hole 9 is provided, serves as a locking boss 10 which locks the cover 2 to the housing 1 in the position shown in FIG. 2. It will be appreciated that the cover may be hinged and formed in other ways so that the cable may be inserted and relieved in any direction.

1. A termination device, e.g. for a multiconnector and comprising a plurality of protruding terminals and a cover which, upon closing of the device, is adapted to guide and force a wire associated with each terminal down into the terminal to provide an electrical connection between the wire and the terminal, and wherein the cover is hinged to the device such that the wires may be positioned correctly in an open position, and such that the wires are in place in the respective terminals in a closed position, characterized in that a first number of terminals distributed in directions crosswise of the hinge axis is greater than a second number of terminals distributed in direction parallel to said axis and that the distance from the hinge axis to the terminals varies substantially evenly distributed between a smallest distance and a greatest distance.

2. A device according to claim 1, characterized in that all terminals are mutually differently spaced from the hinge axis.

3. A device according to claims 1-2, characterized in that the terminals are elastically movable transversely to the hinge axis.

4. A device according to claims 1-3, characterized in that the slit between the terminals for receiving a wire is arc-shaped and substantially concentric with the hinge axis.

5. A device according to claims 1-4, characterized in that the cover has grooves for receiving an associated wire and for guiding the wire when the cover is closed.

6. A device according to claim 5, characterized in that the grooves have a width corresponding to the thickness of the wires.

7. A device according to claim 5, characterized in that the grooves close to the hinge axis are wider than the grooves further away from the hinge axis, measured transversely to the hinge axis.

8. A device according to claims 5-7, characterized in that the grooves are open out toward a pair of opposed sides of the cover.

9. A device according to claims 5 8, characterized in that the grooves are positioned at the bottom of the cover, and that the cover has a through hole from top to bottom for receiving a cable which contains said wires.

10. A device according to claims 5-9, characterized in that at least one of the sides of the cover has a hole for receiving a cable which contains said wires.
